(19) United States
(12) Patent Application Publication
(10) Pub. No.: US 2022/0401971 A1
(43) Pub. Date: Dec. 22, 2022

(54) Spraying Device

(71) Applicant: Thomas J. Tardif, Sabattus, ME (US)

(72) Inventor: Thomas J. Tardif, Sabattus, ME (US)

(21) Appl. No.: 17/843,405

(22) Filed: Jun. 17, 2022

Related U.S. Application Data
(60) Provisional application No. 63/212,214, filed on Jun. 18, 2021.

(51) Int. Cl. B05B 1/20; B05B 9/01; A01G 25/14

(52) U.S. Cl. CPC B05B 1/20; B05B 9/01; A01G 25/14

(57) ABSTRACT

The spraying device is configured to connect to a hose and deliver a large volume of water over of a plant's root zone or canopy with relatively low pressure and without flash flooding or erosion. The device has a tubular irrigation nozzle design that allows for effective placement of the device over any area where application of fluid is necessary, the tubular design allowing rotation of the nozzle from one side to another with ease providing unique control over water stream.

### BACKGROUND INFORMATION

### Field of the Invention

The invention relates to spraying devices and, in particular, nozzles for hoses.

### Discussion of Prior Art

Conventional hose nozzles offer multi-setting spray functions that typically create either a very high-pressure but narrow stream or water directed at a small surface area or wider spray patterns with very low-pressure flow rates. There are also different “water wand products” available that typically provide 0.2-1 gallons per minute flow of water using circular multi-setting spray nozzles.

In many settings, these high-pressure/narrow-stream and low-pressure-pressure/wide-stream settings do not provide the required water flow. Either for example, these delivery flows are not particularly advantageous with the irrigation and/or fertigation of plants grown in fabricated containers, indoors or outdoors, that typically require manual irrigation and/or fertigation. These situations require the dispersion of a comparatively large volume of water over a comparatively large area of a plant's root zone with relatively low pressure so as to avoid a form of flash flooding and/or erosion. Such situations may also include plants that are wrapped in netting or that have roots that are obstructed, such as with trellis netting as these conventional misshapen oversized nozzles easily become hooked or trapped within trellis netting or plant branches causing costly damage.

Additionally, conventional misting nozzle outlets have either adjustable cone spray patterns or have various horizontal angle patterns, e.g. 90 degrees, 180 degrees, etc., but in all cases the nozzles have a 180-degree vertical angle pattern, creating an inefficient application.

What is needed, therefore, is a delivery device that is able to deliver a large volume of water over a relatively wide area with sufficient and controllable water pressure in a convenient and efficient manner.

### BRIEF SUMMARY OF THE INVENTION

The invention is a high volume-low pressure (HVLP) tubular irrigation wand nozzle adapted for use in commercial, residential, and general garden applications, and that is particularly well adapted to be used for watering roots of a potted plant.

The device is configured to deliver a large volume of water, with a flow rate of approximately 1 to 15 Gallons Per Minute (“GPM”) at approximately 50 pounds per square inch (“PSI”), based on optional nozzle lengths and variable water flow rate. The device delivers the water over a large surface area, usually in the range of 5 to 40 square inches, with the variation based on optional nozzle lengths and variable water flow rate, via the tubular nozzle design.

This design also allows for the dispersion of the large volume of water over a large area of a plant's root zone or canopy with relatively low pressure and without flash flooding, erosion, or other similar damage. More specifically, the tubular irrigation nozzle design provides an effective solution to the existing problem that occurs when using traditional circular multi-spray nozzles, specifically the problem of being too bulky and misshapen to navigate between a plant's branches.

The low-profile tubular design allows effective placement of the device over any area where application is necessary, the tubular design allowing rotation of the nozzle from one side to another with ease providing unique control over water stream.

The device may be manufactured in a variety of dimensions. In one preferred embodiment, the device measures approximately 3 feet and 6 inches in length, and in a second preferred embodiment the device measures approximately 6 feet in length. In each embodiment, the device is tubular pipe with the pipe opening having a diameter in the range of approximately ½ of an inch to approximately ¾ of an inch. One end of the pipe has a conventional attachment mechanism for connecting to a conventional hose while the opposite end of the pipe is sealed in a watertight manner. The end closest to the hose includes one or more handles and an on/off valve. The device also includes a plurality of perforations on an underside of the pipe, relative to the handles, to disperse the water through the pipes. The size, placement and spacing of the perforations may vary based on the overall length of the pipe, however, one suitable embodiment includes the perforations in an approximate shape of a straight line, spaced approximately 1 inch apart, and that having openings with a diameter of roughly 11/64 of an inch. The perforations may also include nozzles that cause the water to exit the device in various shapes and/or directions.

### BRIEF DESCRIPTION OF THE DRAWINGS

The present invention is described with reference to the accompanying drawings. In the drawings, like reference numbers indicate identical or functionally similar elements. The drawings are not drawn to scale.

FIG. 1 is a side view of a device according to the invention showing a user operating the device at a waist level.

FIG. 2 is a side view of a device showing a user operating the device from an overhead position.

FIG. 3 is a perspective view of the device showing the top of the device.

FIG. 4 is a perspective view of the device showing the perforation on a bottom side of the tubular member as well as a handle on the top side.

FIG. 5 is a perspective view of the device showing the handles and on/off valve.

FIG. 6 is a plan view of the bottom of the device showing an array of nozzles in the perforations.

FIG. 7 is a close view of the bottom side of the end of the device showing some perorations in an open configuration and some having nozzles.

### DETAILED DESCRIPTION OF THE INVENTION

The present invention will now be described more fully in detail with reference to the accompanying drawings, in which the preferred embodiments of the invention are shown. This invention should not, however, be construed as limited to the embodiments set forth herein; rather, they are provided so that this disclosure will be complete and will fully convey the scope of the invention to those skilled in the art.

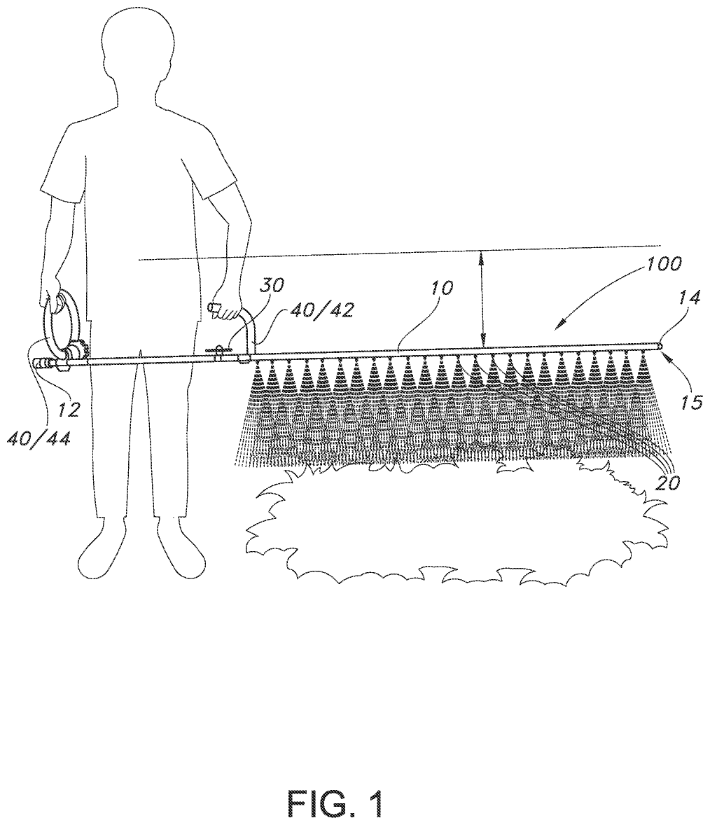

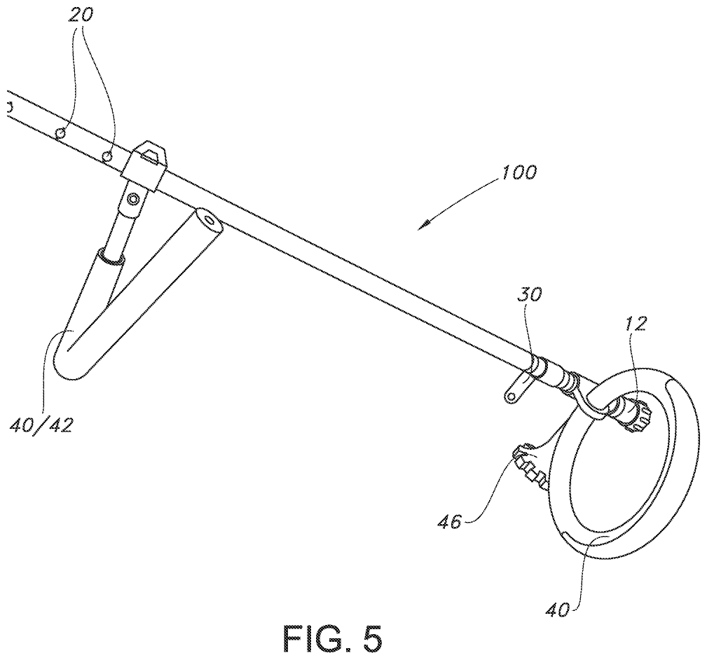

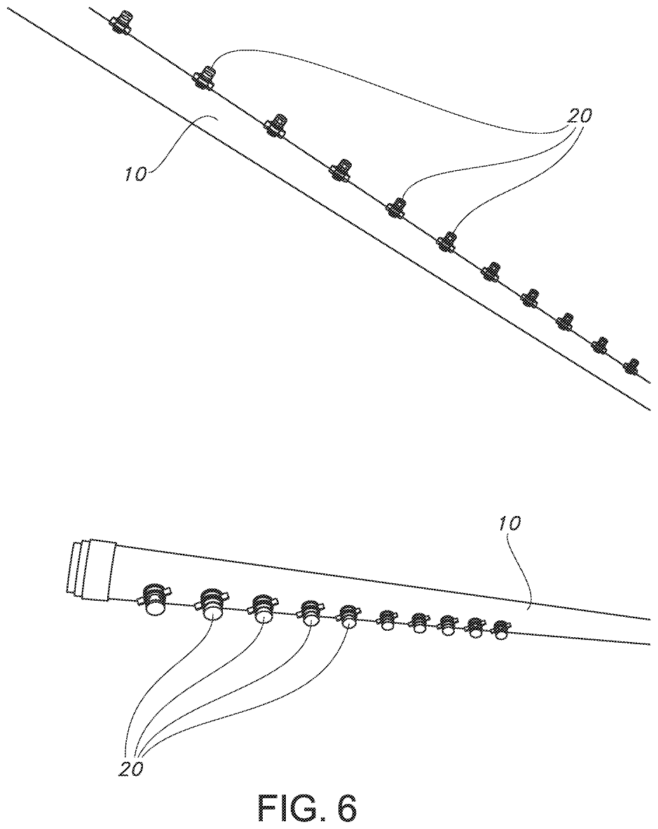

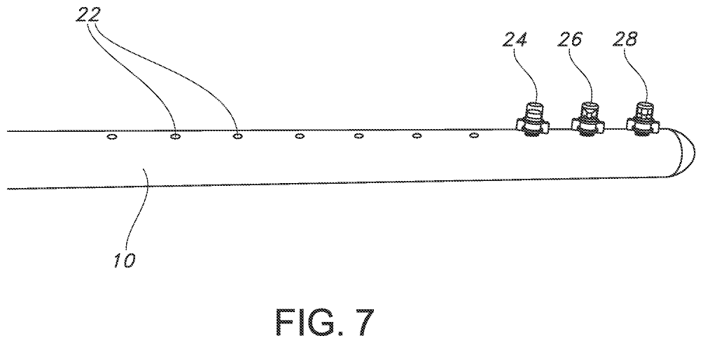

FIGS. 1-7 illustrate a spraying device 100 according to the invention. The spraying device 100 includes a delivery conduit 10 having a plurality of perforations or openings 20, the delivery conduit 10 adapted to connect to a liquid supply, such as a garden hose. The plurality of openings 20 approximately arranged in a straight line on a bottom side of the conduit 10 and configured to disperse the liquid out of the device 100. The device 100 also includes one or more handles 40.

The arrangement and configuration of the perforations 20 along conduit 10, as well as the positioning of the one or more handles 40, creates a spraying device that disperses large volumes of fluid over a large surface area rapidly and ergonomically, which lessens operator fatigue and improves productivity. The specific volume of water dispersed and the specific area that the device 100 covers in a given period varies based on the specific construction of the device. However, in general the device 100 is able to cover an area between approximately 5 square inches and approximately 40 square inches with a flow rate 1 to 15 Gallons Per Minute (“GPM”) at a supply pressure of approximately 50 pounds per square inch (“PSI”).

The delivery conduit 10 is a cylindrical conduit having sufficient rigidity to prevent the device from bending as water flows through the conduit 10 and out through the perforations 20. The conduit is open on one end 12 where it connects to the water supply, for example, by using a conventional threaded fastener. The second end 14 is sealed in a watertight manner with a smooth round cap 15. The cap 15 prevents the device 100 from becoming caught in a plants' trellis support netting and/or branches that are located around and/or throughout the entire plant. The diameter of the conduit may vary, however, a diameter between approximately ½ inch and approximately ¾ inch is preferred.

The openings 20 are located at and near the second end 14. More specifically, the openings 20 start near the second 14 and are arranged in an approximate shape of a straight line along the bottom of the device 100 towards the first end 12, with the line of openings 20 coming to an end before they reach an operators position to avoid dispersing fluid on the operator or unintended application surfaces.

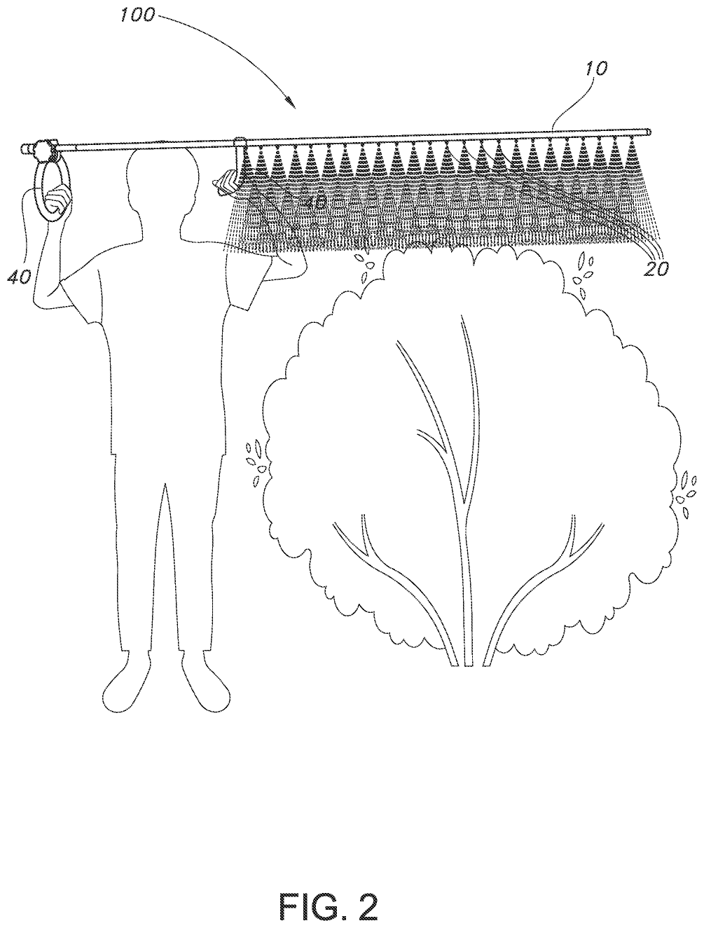

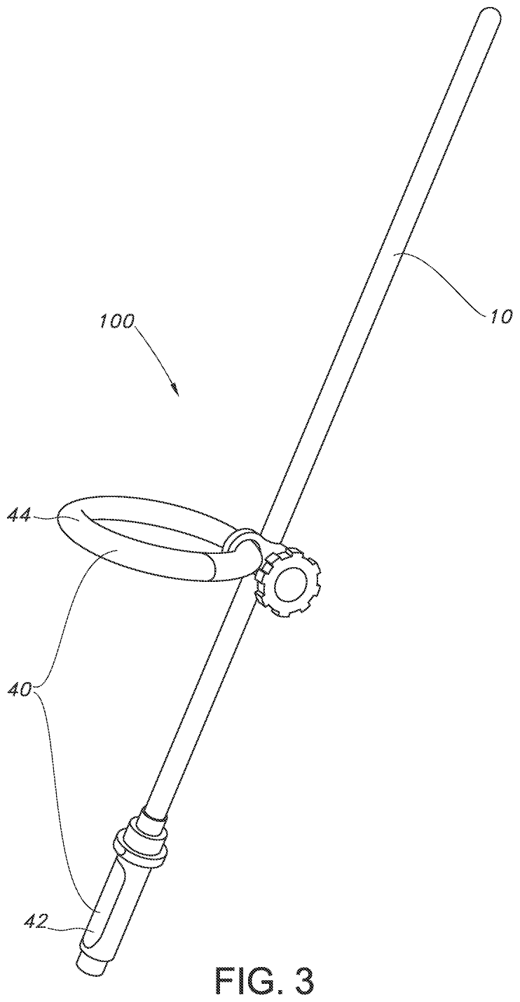

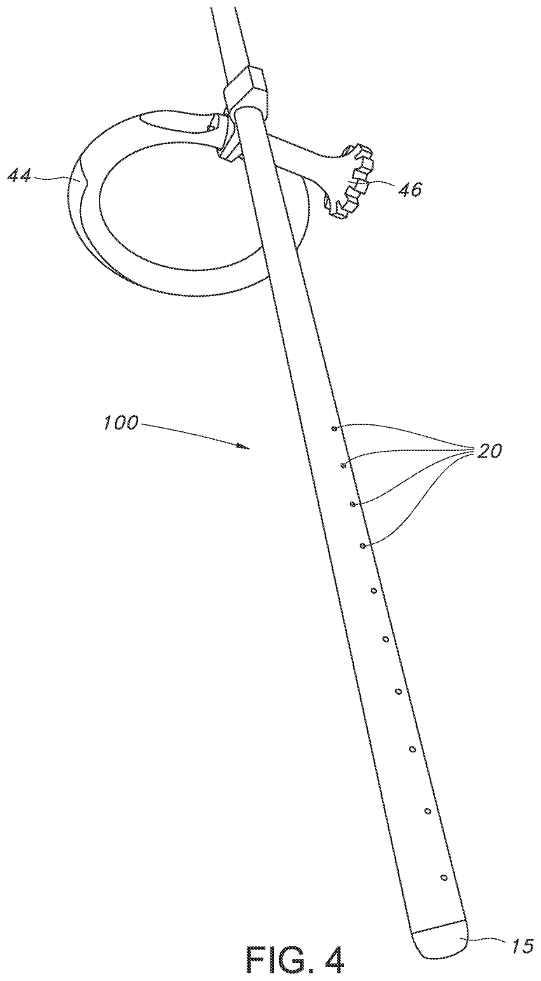

In one embodiment, illustrated in FIGS. 3 and 4, the conduit 10 is approximately three feet and six inches in length. There are 10 openings 20 that are each spaced approximately 1 inch apart. The 10 openings 20 are arranged in a line starting approximately one inch prior to the cap 15 and extending towards the first end 12 of the device, thereby creating a delivery length of about 9 inches. In a second embodiment, shown in FIGS. 1 and 2, the conduit 10 is approximately 6 feet in length and has approximately 24 openings 10 that are spaced approximately 2 inches apart.

In most instances, the perforations 20 are predrilled holes 22 in the conduit 10. The size of the perforations 20 may also vary, for example, 11/64 inch is preferred, however, 3/32 of any inch is suitable for some applications. Nozzles 24, 26, 28, may also be inserted into the perforations 20, for example, by using a threaded fastener connection method. As noted above, conventional misting nozzle outlets have an efficiency problem. To address that, interchangeable nozzle outlets 24, 26, 28 may be provided, with different outlets having either adjustable cone spray patterns or having various horizontal angle patterns, e.g. 90 degrees, 180 degrees, etc. In all cases the nozzles' 24, 26, 28 have a 180-degree vertical angle patterns. The device may also be equipped with a variety of these nozzles in order to deploy a combination of horizontal and angle patterns, e.g. having an X axis of 90 degrees, 180 degrees, and/or 360 degrees, and a Y axis ranging between 45 degrees and 90 degrees. This enables each user to create a delivery path with the utmost precision and consistency for the specific purpose/plant. The perforations 20 may also be plugged if fewer perforations 20 are desired, for example, to decrease the delivery path and/or increase flow rate.

The spraying device 100 also includes an on-off valve 30. For example, a conventional barb or threaded ball valve may be used, the valve having a first position that opens the valve and allows liquid to flow into the device and a second position that closes the valve and prevents liquid from flowing through the device. In this embodiment, once the water supply/hose is activated there is a constant flow of water into the device 100, with the on-off valve 30 controlling the delivery of water out through the openings 20.

One or more handles 40 may also be provided. Each of the embodiments shown in FIGS. 1 and 2 and, separately, in FIGS. 3 and 4 include two handles 42, 44, that are configured in different manners for different purposes. For example, the design shown in FIGS. 3 and 4 is primarily for irrigation/fertigation of plant root zones in micro scale commercial agriculture. Here, the user is able to use the ring handle 44 to support the weight of the device 100 while using the straight end handle 42 to control the direction and positioning of the device 100 over the root area. The device shown in FIGS. 1 and 2 illustrates a handle arrangement for the longer configuration. In this embodiment, the device is shown in a configuration adapted for small to large-scale indoor or outdoor commercial agriculture, illustrating its use with a foliar spray application. In both configurations, the ring handle 44 includes a conventional adjustment mechanism 46 to enable the user to modify the angle of the handle 44 relative to the conduit 10 for a more ergonomic fit.

The device 100 may be made from a variety of materials, for example, a plastic such as high-density polyethylene is sufficient. Other materials such as aluminum piping and/or galvanized steel also are sufficient.

It is understood that the embodiments described herein are merely illustrative of the present invention. Variations in the construction of the spraying device may be contemplated by one skilled in the art without limiting the intended scope of the invention herein disclosed and as defined by the following claims.

What is claimed is:

1. A device adapted to deliver liquid from a liquid source, the device comprising:
a delivery conduit that has a first end, a second end, a top side, and a bottom side, the first end adapted to connect to the liquid source;
a plurality of perforations on the bottom side of the delivery conduit;
wherein as the liquid flows from the liquid source and into the delivery conduit is exits the delivery conduit through the plurality of openings.

2. The device of claim 1, wherein the plurality of perforations are arranged in the approximate shape of a straight line.

3. The device of claim 1, wherein the delivery conduit includes an valve that has first position and a second position and wherein placing the valve in a first position allows the liquid to flow into the delivery conduit to the plurality of perforations and wherein placing the valve in the second position prevents the liquid from flowing through the delivery conduit to the plurality of perforations.

4. The device of claim 1, further including at least one handle including a first handle, the first handle attached to the top side of the delivery conduit.

5. The device of claim 4, the at least one handle including a second handle that is connected around the delivery conduit at a location near the first end, the first handle having a ring shape and positioned near the plurality of perforations.

6. The device of claim 4, the at least one handle including a second handle that is connected to the top side and that has a u-shape, the first handle having a ring shape, and wherein the first handle is positioned near the first end and the second handle is positioned near the plurality of perforations.

7. The device of claim 2, wherein the plurality of perforations includes at least 10 perforations.

8. The device of claim 7, wherein each perforation in the plurality of perforations is spaced at least one inch apart from each other perforation.

9. The device of claim 2, wherein the plurality of perforations includes at least 24 openings.

10. The device of claim 9, wherein each perforation in the plurality of perforations are spaced approximately two inches apart from each other perforation.

11. The device of claim 1 wherein the second end is closed with a smooth rounded cap.
